(19) United States
(12) Patent Application Publication
(10) Pub. No.: US 2005/0053906 A1
(43) Pub. Date: Mar. 10, 2005

(54) Playing apparatus for audio book and voice card, and controlling method thereof

(75) Inventors: Kyong Ho Kim, Seoul (KR); Kwan Sun Park, Suwon (KR); Bong Rok Kim, Suwon (KR); Hak Jin Kang, Seongnam (KR)

Correspondence Address: STAAS & HALSEY LLP, SUITE 700, 1201 NEW YORK AVENUE, N.W., WASHINGTON, DC, 20005, US

(73) Assignee: SYhitech.com, Kyeongki-do (KR)

(21) Appl. No.: 10/658,753

(22) Filed: Sep. 10, 2003

(51) Int. Cl. G09B 5/00

(52) U.S. Cl. 434/317

(57) ABSTRACT

Disclosed herein is a playing apparatus for audio book and voice card, which is capable of acoustically playing contents of an audio book and a voice card used for education such as language learning. The playing apparatus for voice card and audio book comprises a voice card sensing unit, an audio book page sensing unit, a voice card transfer unit, a memory including a voice card information storing unit and an audio book information storing unit, a digital information processing unit, a speaker, and a MCU for controlling operation of all components. By providing a control method when the voice card is inserted during the output of the audio book, remaining data of the audio book can be output after a voice card playing mode is executed, without occurrence of errors due to a careless manipulation of the user. Accordingly, since the manipulation of the playing apparatus for audio book and voice card is very simple, even infants/babies can manipulate the playing apparatus easily and conveniently without the occurrence of errors.

### BACKGROUND OF THE INVENTION

1. Field of the Invention

The present invention relates to a playing apparatus for audio book and voice card, which is capable of acoustically playing contents of an audio book and a voice card used for education such as language learning.

2. Description of the Related Art

In general, pictures and sentences are illustrated in each of pages of a book for babies. Babies learn speaking and writing by associating the pictures with corresponding sentences and listening the sentences read by their parents. However, an inconvenience arises in that the parents should read the book for babies. To solve this inconvenience, audio books and apparatuses for playing the same have been developed.

Particularly, audio books and apparatuses for playing the same (hereinafter, referred to as “audio book apparatus”) for recognizing pages of a book and speaking contents of opened pages of the book have been developed and used.

As one example of conventional audio books, Japanese Utility Model Laid-Open Hei 2-62464 (published on May 10, 1990) discloses an audio book playing apparatus for recognizing a page of a picture book by means of a bar code reader and playing contents of the page with sound. However, a problem arises in that it is actually impossible for babies who are lacking in recognition power to use such a bar code reader.

In addition, Korean Utility Model Laid-Open No. 1996-38427 (published on Dec. 18, 1996) discloses an apparatus for recognizing pages of a book by forming a plurality of dots in each of pages of the book and sensing corresponding dots with an electronic pen containing an optical sensor. However, this utility model also has a problem in that the babies have a difficulty in using the apparatus, just like the above-mentioned Japanese Utility Model Laid-Open Hei 2-62464.

Therefore, it is desired to develop a new audio book and an apparatus for playing the same, which is capable of automatically recognizing a kind and a page of the book without a direct and selective manipulation, such as a pointing, from a user and playing contents of the page by means of an audio, so that infants/babies can use more conveniently the book and the apparatus.

In addition to the audio book, a voice card having pictures and symbols printed thereon for outputting music and messages related to contents printed on the card is being widely used in education for the infants/babies.

The voice card mainly uses a magnetic tape. Pictures and corresponding characters such as alphabets or Korean letters are printed on the front side of the voice card. A magnetic tape having voice information corresponding to contents of the pictures recorded thereon is attached on the bottom side 0f the voice card. Learning behavior using such a voice card is accomplished by manually moving the voice card inserted into an insertion opening of a voice card player in a horizontal direction and reproducing voice information recorded into the magnetic tape.

However, since the voice card is manually moved, a voice quality is deteriorated due to ununiformity of moving speed. In addition, since reproduction time is limited by a length of the magnetic tape (i.e., a length of the voice card), there is a difficulty in storing and using story books, songs, etc. Moreover, there is a problem in that babies manipulating the voice card have a difficulty in manually moving the voice card with a constant speed. Also, since a process for recording the voice information on the magnetic tape and a process for attaching the magnetic tape to every voice card are necessary, the magnetic tape-typed voice card has a problem in terms of cost.

Furthermore, the above-mentioned audio book playing apparatus and a learning reproduction system using the above-mentioned voice card have been developed as a technique independent to each other. Therefore, since two or more different products should be purchased to accomplish stepped learning and multifunction learning for the babies, there is a problem of economical burden and wastefulness of resources.

### SUMMARY OF THE INVENTION

Accordingly, the present invention has been made keeping in mind the above problems occurring in the prior art, and an object of the present invention is to provide an playing apparatus for voice card and audio book, which is capable of performing both of a function of playing a voice card and a function of outputting contents of an audio book, so that infants/babies can manipulate the playing apparatus simply and easily without occurrence of errors.

In order to accomplish the above object, the present invention provides a playing apparatus for voice card and audio book for outputting audio data from a voice card including a bar code indicating a location address of audio data and an audio book including audio book information and location address information of voice data corresponding to each of pages of the voice book, the playing apparatus comprising: a voice card sensing unit including a photo sensor for outputting a first signal to sense an insertion of the voice card and a second signal to sense the bar code, an audio book page sensing unit for sensing the audio book information and the location address information of voice data, a voice card transfer unit driven when the first signal is output from the voice card sensing unit, for transferring the voice card at a prescribed speed, a memory comprising a voice card information storing unit including voice card data location information corresponding to the second signal of the voice card output from the voice card sensing unit and audio data corresponding to the voice card data location information, and an audio book information storing unit including audio book information output from the audio book page sensing unit and audio book audio data location information corresponding to page address information of the audio book, a digital information processing unit for decoding the data stored in the memory into an analog signal, a speaker for outputting the analog signal from the digital information processing unit, and a MCU for controlling the digital information processing unit and the speaker to cause the voice card transfer unit to be driven according to signals from the voice card sensing unit and the audio book page sensing unit, determine a data address of the voice card, a kind of the audio book and a page address of the audio book, and cause the voice card data and the audio book data to be decoded in the digital information processing unit and then to be output through the speaker, and for controlling such that corresponding audio book data are stored when the voice card insertion signal is input during the output of the audio book data, and then the stored audio book data is output after the data corresponding to the inserted voice card are output.

Preferably, the address information of the voice card stored in the memory consists of a track address and an index address, the track address is defined based on the number of languages used in the voice card, and the index address, which is a low level address of the track address, is defined based on the number of characters or symbols used in the voice card and specifies a location on which data of the voice card are stored.

Preferably, the audio book page sensing unit outputs a page sensing signal by using one selected from a group consisting of a contact switch, an optical sensor, a lead sensor, a hole sensor, and an electronic pen.

Preferably, the audio book includes a hole sensor and an electronic pen identification mark, and the MCU determines a kind of the audio book based on a hole sensor sensing signal output from the audio book page sensing unit and determines page location information based on an electronic pen sensing signal.

Preferably, the playing apparatus further comprises a buffer for storing the audio book data when the voice card insertion signal is input during the output of the audio book data.

To accomplish another object, the present invention provides a method for controlling a playing apparatus for voice card and audio book for outputting audio data from a voice card and an audio book, the voice card including a bar code indicating a location address of audio data, the method comprising the steps of: a) determining whether a sensing signal is input from an audio book page sensing unit, b) reading the sensing signal and determining an address of the audio book and page corresponding to the sensing signal when it is determined in the step a) that the sensing signal is input, c) applying data of the audio book corresponding to the address determined in the step b) to a digital information processing unit, d) outputting the audio data decoded in the digital information processing unit through a speaker, e) determining whether a voice card insertion signal is input during the output of the audio data, f) stopping the output of the audio data of the audio book and storing remaining decoded data when it is determined that the voice card insertion signal is input, g) driving a card transfer unit, h) reading a signal input from a voice card sensing unit and determining a bar code and an address of voice card audio data corresponding to the bar code, based on the signal, i) applying the voice card audio data corresponding to the address determined in the step h), j) outputting the data decoded in the digital information processing unit through the speaker, k) determining whether the output of the data decoded in the digital information processing unit is completed, and l) outputting the data of the audio book stored in step f) through the speaker when it is determined in the step k) that the output of the data decoded in the digital information processing unit is completed.

Preferably, the remaining decoded data stored in the step f) are stored in a buffer.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram showing a configuration of a playing apparatus according to the present invention;

FIGS. 2 to 4 are flow charts showing a control procedure of a playing apparatus according to the present invention;

FIG. 5 is a schematic view showing one embodiment of a voice card applied to the present invention; and

FIG. 6 is a schematic view showing one embodiment of a playing apparatus according to the present invention.

### DESCRIPTION OF THE PREFERRED EMBODIMENTS

Hereinafter, the present invention will be in detail described by way of a preferred embodiment with reference to the accompanying drawings.

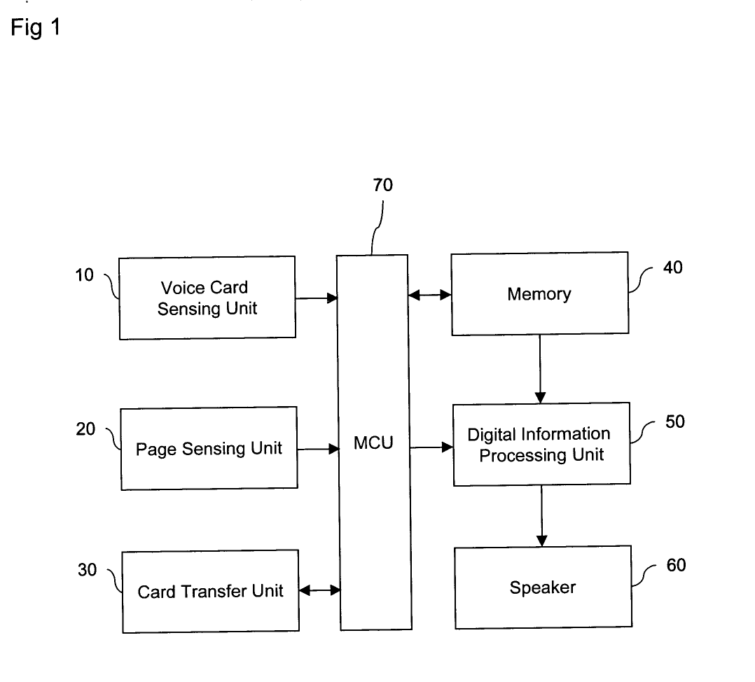

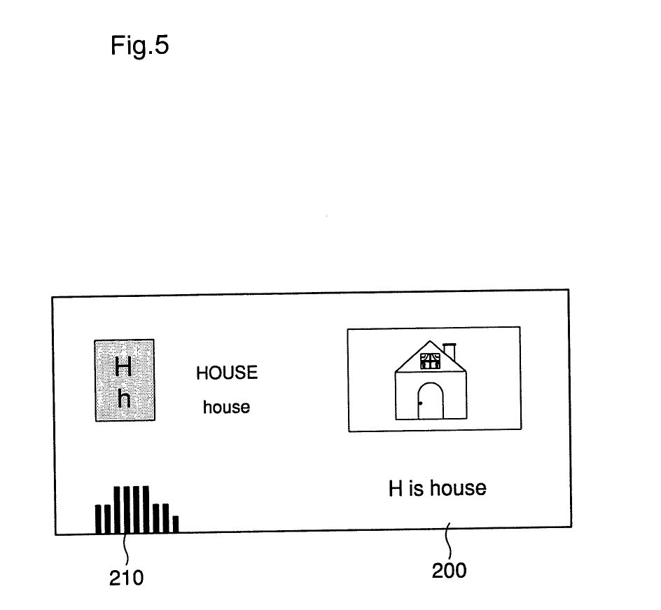

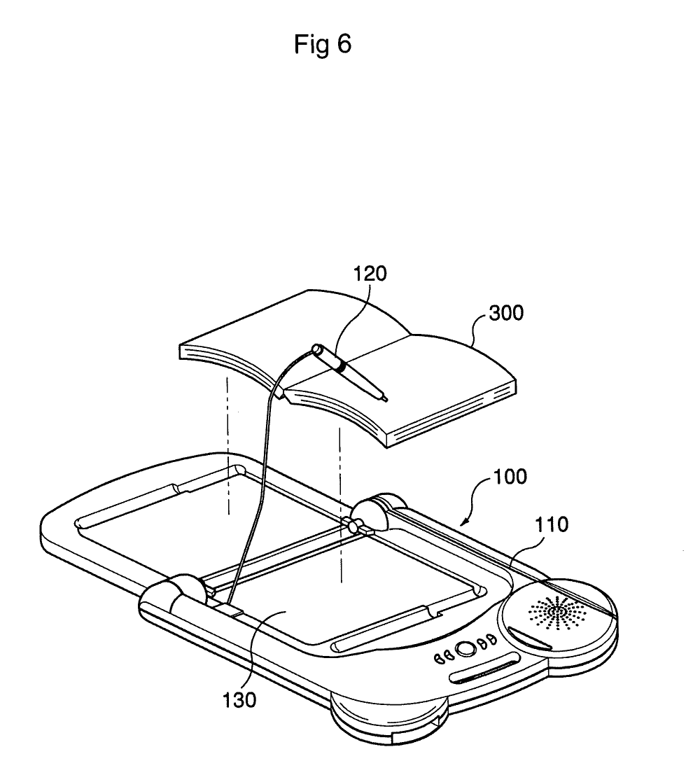

FIG. 1 is a schematic block diagram showing a configuration of a playing apparatus according to the present invention, FIG. 5 is a schematic view showing one embodiment of a voice card applied to the present invention, and FIG. 6 is a schematic view showing one embodiment of a playing apparatus according to the present invention.

A playing apparatus of the present invention can use both of a voice card and an audio book. As shown in FIG. 5, pictures, symbols, etc. to be represented, and characters or sentences meaning them are printed on the voice card. Also, the voice card includes a bar code representing an address corresponding to audio data to be reproduced after the voice card 200 is inserted into the playing apparatus.

As shown in FIG. 6, a body 100 of the playing apparatus includes a book support 130 on which an audio book 300 is mounted and a voice card insertion opening 110 into which the voice card 200 is inserted.

A circuit for performing a function of the playing apparatus 100 is located inside the body 100. As shown in FIG. 1, an internal structure for performing the function of the playing apparatus includes a voice card sensing unit 10, a page sensing unit 20, a card transfer unit 30, a memory 40, a digital information processing unit 50, a speaker 60, and a multi-controller unit (MCU) 70.

In addition to these components, a function selection unit can be included so that a user can perform selection, repeated playing, stop, etc. of functions of voice card and audio book.

The voice card sensing unit 10 consists of a photo sensor and is provided in the voice card insertion opening 110. When the voice card 200 is inserted, the photo sensor applies an insertion sensing signal to the MCU 70. While the voice card passes through the voice card insertion opening 110, the photo sensor recognizes a bar code 210 printed on the voice card 200 and applies a bar code sensing signal to the MCU 70.

The card transfer unit 30 is provided in the voice card insertion opening 110. The card transfer unit 30 includes a card insertion sensing sensor, a transfer motor, and a transfer roller, which is mounted on a rotating axis of the transfer motor and has an outer surface adhering closely to the voice card. The voice card sensing unit 10 is preferably implemented by the card insertion sensing sensor. When the voice card is inserted into one entrance hole of the card insertion opening 110, a sensing signal is input from the card insertion sensing sensor to the MCU 70 and a transfer motor driving signal is output from the MCU 70 according to the sensing signal from the photo sensor. While the sensing signal from the card insertion sensing sensor is applied to the MCU 70, the transfer motor is actuated to transfer the voice card at a prescribed speed.

The memory 40 includes a voice card information storing unit containing voice card data location information corresponding to the bar code sensing signal of the voice card output from the voice card sensing unit 10 and audio information corresponding to the location information, an audio book information storing unit containing audio book information output from the audio book page sensing unit, data location information of the audio book and page of each audio book for recognizing a kind of audio book, e.g., audio book number in the case of a complete works series, corresponding to page address information, and audio information corresponding to the data location information.

The address information of the voice card stored in the memory 40 consists of a track address and an index address. The track address is defined based on the number of languages used in the voice card. The index address, which is a low level address of the track address, is defined based on the number of characters or symbols used in the voice card and specifies a location on which data of the voice card are stored.

The digital information processing unit (hereinafter, referred to as decoder) 50 decodes data input from the memory 40 to convert the data into an analog signal.

The speaker 60 outputs the analog signal generated by the decoder 50.

The audio book page sensing unit 20 can use one or more of a contact switch, an optical sensor, a lead switch, a hole sensor, or an electronic pen. The electronic pen is shown in FIG. 6. In FIG. 6, reference numeral 120 designates an electronic pen employed as the audio book page sensing unit.

The audio book page sensing unit 20 senses the audio book information and an opened page of the audio book 300 mounted on the book support 130 of the body of the playing apparatus, and applies a sensing signal to the MCU 70.

In a system using the contact switch, the contact switch is mounted on every page of the book. A page of the book is recognized by using on/off operation, which is generated due to a pressure between one page and another page, of the contact switch.

In a system using the lead switch, a magnet is mounted on every page of the book and the lead switch is built in a location of the book support 130 corresponding the magnet of every page. A page of the book is recognized by an interaction between the magnet and the lead switch.

In a system using the hole sensor, a magnet fragment is inserted into every page of the audio book and a hole sensor for differentially outputting a voltage in proportion to the intensity of magnetic field is provided in the body of the apparatus. A page of the book is recognized based on an output signal from the hole sensor. The hole sensor is a sensor using a hole effect. According to the hole effect, when a current flows in a conductor or a semiconductor and a magnetic field is applied in a direction perpendicular to a flow direction of the current, a force is effected in a direction perpendicular to the magnetic field by a Fleming's left hand rule and a potential difference is generated in a direction perpendicular to the magnetic field by carriers moved under the effect of this force. When a magnitude of magnetic flux density is varied, the potential difference is varied in proportion to the variation of the magnetic flux density. By inputting into the MCU a signal generated and amplified after the variation of the potential difference is differentially output, a page of the book can be recognized whenever the page turns over. Magnet fragments for the hole sensor are inserted and fixed one by one at a regular interval such that they do not intersect each other in a plane. When the audio book in a closed state is mounted on a lower support of the body of the playing apparatus, each of magnet fragments is arranged on a corresponding hole sensor directly below the magnet fragment. The hole sensor can be used to discriminate a kind of audio book. In other words, if the audio book is a complete works series of audio book, magnet fragments of different intensities are inserted in every audio book, and the number of the audio books is discriminated according to an output signal of the hole sensor.

In a system using the electronic pen, an identification mark is included in each of pages of the audio book, and when the identification mark is marked by the electronic pen 120, a page and/or an address of voice data to be output are discriminated according to an input signal from the electronic pen 120.

On the other hand, one embodiment of the audio book in a system using the optical sensor is as follows. Small apertures are formed in each of pages of the audio book. A page is recognized by using optical sensors to sense light transmitted through the small apertures. In other words, optical sensors are formed at locations corresponding to small apertures formed in each of pages of the audio book. As the number of optical sensors exposed to light is varied when pages of the audio book turn over, address information of the pages is recognized by sensing potentials of the optical sensors.

As another embodiment of the system using the optical sensor, there is a system in which a photo-electric conversion device such as a photo sensor is used as means for recognizing pages of the audio book. As the photo-electric conversion device, a device with a light projecting unit (a portion to project light) and a light receiving unit (a portion to receive reflected light) formed integrally or a device having only the light receiving unit receiving light incoming from the outside is employed. More detailed description of the audio book using the optical sensor is as follows. The audio book consists of a plurality of pages and each of the plurality of pages consists of a transparent portion and a content portion. The transparent portion is formed with a light reflecting unit corresponding to the optical sensor on the book support 130 in one to one way, and contents such as sentences or pictures are described on the content portion. The transparent portion is mainly made from a light transmittable material such as polyester (PET) or polypropylene (PP). The light reflecting unit is formed by printing a light transmittable material, generally black dot, on the transparent portion by means of a screen printing technique or an indirect printing technique.

When the audio book is placed on the book support 130, the light reflecting unit is located directly above the optical sensor of the book support 130 in a one to one relation between them. Light projected from each of light projecting units is wholly reflected at the light reflecting unit and is input into the light receiving unit. If a light receiving signal is input to all optical sensors, it means that a cover page of the voice book turned over, and accordingly the MCU controls contents of the cover page to be output. When next page of the voice book turns over, only light reflected from the light reflecting unit of the remaining pages, of the light projected from the optical sensor is input to the light receiving unit, and the MCU 70 recognizes a page number of the voice book according to the input light.

The audio book page sensing unit 20 can employ a combination of the system using the electronic pen with the systems using the contact switch, the optical switch, the lead switch, and the hole sensor, as described above. For example, the number of audio books can be recognized by the systems using the optical sensor or the hole sensor, while pages or output contents can be recognized by the system using the electronic pen.

According to the operation described as above, after receiving the address signal of the kind (the number) and/or page of the audio books, the MCU 70 determines which page of which audio book is indicated by this received address signal, and reads in the digital data stored in a corresponding address signal in the audio book storing unit containing in the memory 40. The decoder 50 converts the digital data into a voice to be reproduced through the speaker under the control of the MCU 70. The audio book information storing unit stores address information about a page and voice information about the page in a way similar to the voice card information storing unit.

The MCU 70 drives the voice card transfer unit 30 upon receiving the voice card insertion signal, determines a location of voice card data based on the voice card bar code sensing signal output from the voice card sensing unit as the voice card is transferred, and controls the audio data stored in the location of the voice card data to be output through the speaker after the audio data are decoded in the digital information processing unit. In addition, the MCU 70 determines a location of audio book data based on an output signal of the audio book page sensing unit 20, controls the audio data stored in the location of the audio book data to be output through the speaker, and controls such that corresponding audio book data are stored when the voice card insertion signal is input during the output of the audio book data, and then the stored audio book data is output after the data corresponding to the inserted voice card are output.

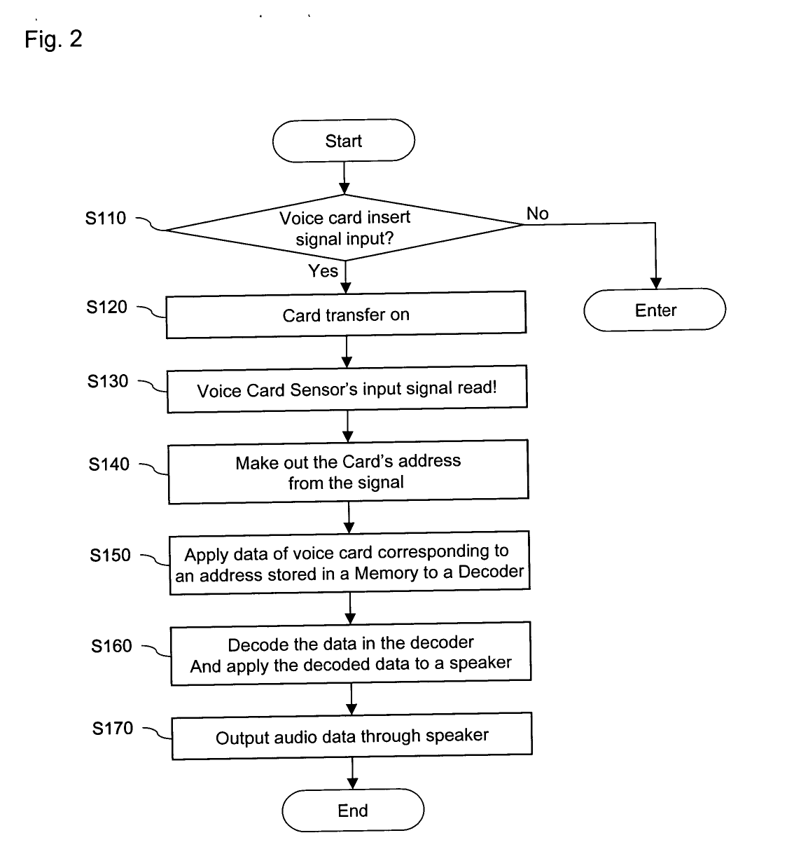

Now, the operation of the playing apparatus for audio book and voice card constructed as above will be described with reference to FIGS. 2 to 4.

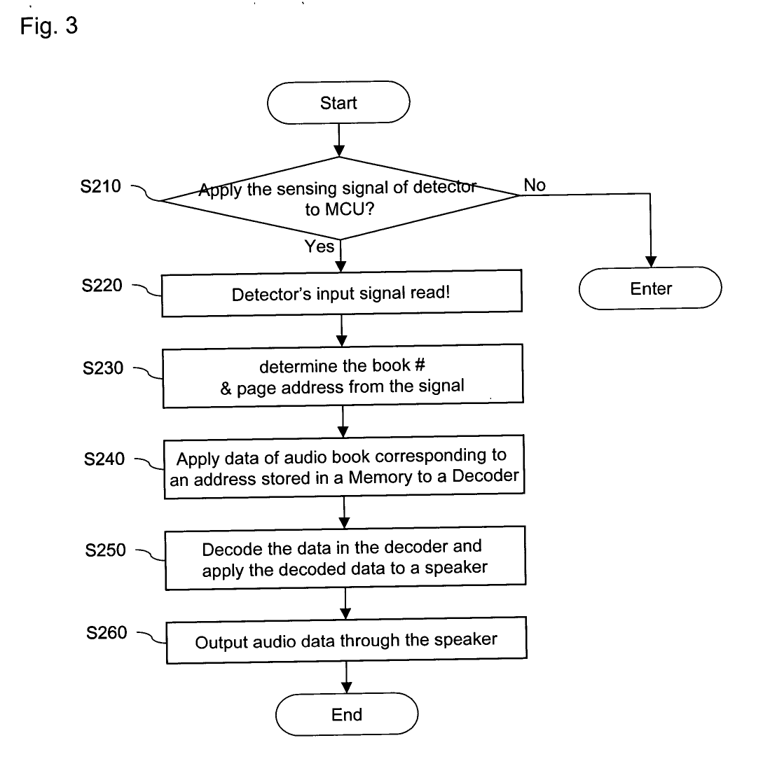

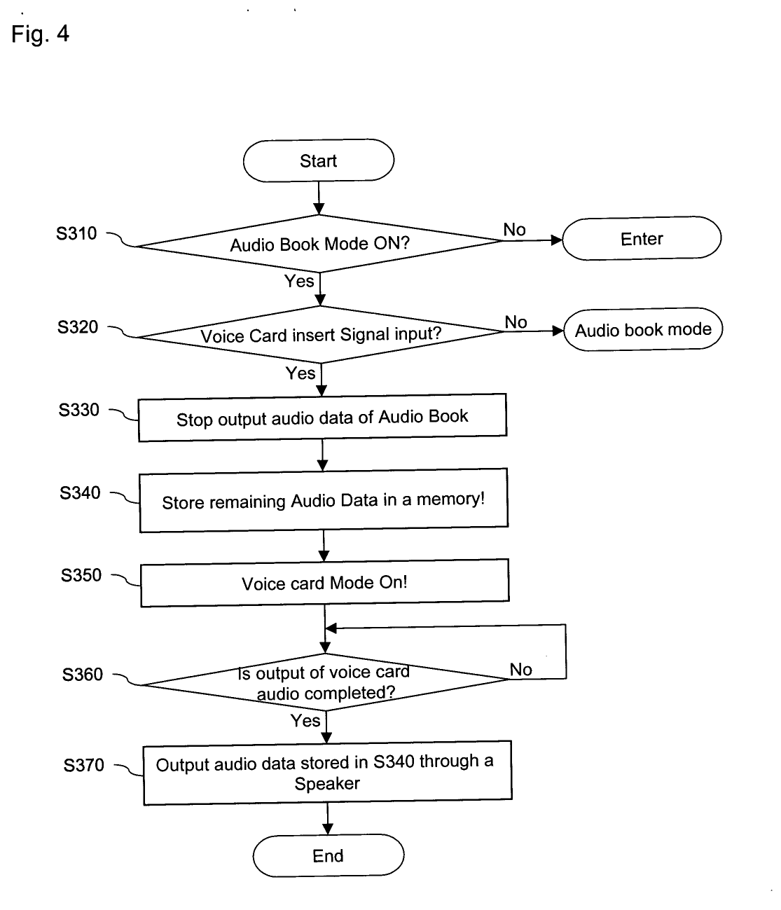

FIG. 2 is a flow chart showing an operation control procedure of the playing apparatus when the voice card is inserted into the playing apparatus, FIG. 3 is a flow chart showing an operation control procedure of the playing apparatus when the audio book is mounted on the playing apparatus, and FIG. 4 is a flow chart showing a control procedure when the voice card of the audio book output is inserted.

The operation control procedure of the playing apparatus when the voice card is used, as shown in FIG. 2, will be described by way of an example of a voice card including English information corresponding to a picture printed on the front side of the voice card and Korean information printed on the back side of the voice card.

As shown in FIG. 2, when the voice card 200 is inserted into an insertion hole of the card insertion opening 110 of the body of the playing apparatus, a sensing signal is applied from the photo sensor of the voice card sensing unit 10 to the MCU 70 (S110). When the sensing signal of the photo sensor is applied, the MCU outputs a transfer motor driving signal of the voice card transfer unit 30 to drive the transfer motor (S120).

The photo sensor reads a bar code 210 as the voice card 200 continues to be transferred, and transmits address information (e.g., “0, 0”) containing characters to the MCU 70 (S130). The MCU 70 receives the address information, reads voice information corresponding to a track address 0 and an index address 0 stored in the voice card information of the memory (S140), and transmits the read voice information to the digital information processing unit (decoder) 50 (S150). The decoder 50 converts the voice information into an analog voice and reproduces the analog voice through the speaker 60 (S160 and S170).

In addition, if a user wants to listen Korean language corresponding to a printed picture, when the back side of the voice card printed with the Korean language is inserted into the card insertion unit 110, the audio data are reproduced according to the same interaction relation as the front side of the voice card as the card voice card transfer unit 30 is driven.

The above-described embodiment directs to the voice card with one bar code formed in each of the front and back sides of the voice card, but it is to be understood that a plurality of bar codes can be formed in each of the front and back sides of the voice card. For example, for same character and symbol, the front side of the voice card can be printed with a bar code corresponding to alphabets and Japanese letters and the back side of the voice card can be printed with another bar code corresponding to Korean letters, so that three languages can be learned by a single voice card. In this case, as shown in FIG. 5, as the card transfer unit 30 transfers the voice card, the voice information stored in the voice card can be reproduced as English stored in a track address 0 and an index address 0, Korean stored in a track address 1 and an index address 0, and Japanese stored in a track address 2 and an index address 0 of the voice card information storing unit in the memory of the playing apparatus according to the present invention.

As shown in FIG. 3, an embodiment of the control procedure of the playing apparatus when the audio book is used according to the present invention is as follows. In this embodiment, an example of a combination of the systems using the electronic pen and the hole sensor is explained.

When the audio book 200 is mounted on the book support 130 of the body 100 of the playing apparatus and a power source turns on, the hole sensor of the audio book page sensing unit 20 applies a sensing signal to the MCU 70, and when a user marks an identification mark using the electronic pen 120, a sensing signal is applied to the MCU 70 (S210)). The MCU 70 reads the hole sensor sensing signal and/or the electronic pen sensing signal (S220) and determines page addresses of the audio book corresponding to the signals (S230). Then, the audio data of the audio book corresponding to the addresses determined in the step S230 are applied to the digital information processing unit (S240). The audio data decoded in the digital information processing unit are output through the speaker (S250 and S260).

In the case of the combination of the systems using the hole sensor and the electronic pen, the number of the audio books can be discriminated according to the hole sensor sensing signal, and pages and contents thereof to be output can be discriminated according to the electronic sensing signal input from the user. In other words, there is a case that the voice card is inserted without stopping the output of words and sentences containing in the audio book when the user marks a identification mark in a page of the audio book. FIG. 4 shows an embodiment for this case. As shown in FIG. 4, when the voice card is inserted during the output of the audio book and an insertion signal is applied from the photo sensor to the MCU 70 (S310 and S320), the MCU 70 stops the output of the audio book and stores remaining decoded data into a buffer (S330, S340 and S350). Then, the voice card mode shown in FIG. 3 is executed (S360). That is, after reading the signal input from the voice card sensing unit and determining a bar code according to the signal and an address of the voice card audio data corresponding to the bar code, the MCU 70 applies the audio data of the voice card corresponding to the determined address to the digital information processing unit to decode the audio data and then outputs the decoded audio data through the speaker. Then, the MCU 70 determines whether the output of the decoded audio data of the voice card is completed or not (S370), and if it is determined that the output is completed, the data stored in the step S350 are output through the speaker.

As apparent from the above description, by providing the control method when the voice card is inserted during the output of the audio book, remaining data of the audio book can be output after the voice card playing mode is executed, without occurrence of errors due to a careless manipulation of the user.

Accordingly, since the manipulation of the playing apparatus for audio book and voice card according to the present invention is very simple, even infants/babies can manipulate the playing apparatus easily and conveniently without the occurrence of errors.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A playing apparatus for voice card and audio book for outputting audio data from a voice card including a bar code indicating a location address of audio data and an audio book including audio book information and location address information of voice data corresponding to each of pages of the voice book, the playing apparatus comprising:
a voice card sensing unit including a photo sensor for outputting a first signal to sense an insertion of the voice card and a second signal to sense the bar code;
an audio book page sensing unit for sensing the audio book information and the location address information of voice data;
a voice card transfer unit driven when the first signal is output from the voice card sensing unit, for transferring the voice card at a prescribed speed;
a memory comprising a voice card information storing unit including voice card data location information corresponding to the second signal of the voice card output from the voice card sensing unit and audio data corresponding to the voice card data location information, and an audio book information storing unit including audio book information output from the audio book page sensing unit and audio book audio data location information corresponding to page address information of the audio book;
a digital information processing unit for decoding the data stored in the memory into an analog signal;
a speaker for outputting the analog signal from the digital information processing unit; and
a MCU for controlling the digital information processing unit and the speaker to cause the voice card transfer unit to be driven according to signals from the voice card sensing unit and the audio book page sensing unit, determine a data address of the voice card, a kind of the audio book and a page address of the audio book, and cause the voice card data and the audio book data to be decoded in the digital information processing unit and then to be output through the speaker, and for controlling such that corresponding audio book data are stored when the voice card insertion signal is input during the output of the audio book data, and then the stored audio book data is output after the data corresponding to the inserted voice card are output.

2. The playing apparatus according to claim 1, wherein the address information of the voice card stored in the memory consists of a track address and an index address, the track address is defined based on the number of languages used in the voice card, and the index address, which is a low level address of the track address, is defined based on the number of characters or symbols used in the voice card and specifies a location on which data of the voice card are stored.

3. The playing apparatus according to claim 1, wherein the audio book page sensing unit outputs a page sensing signal by using one selected from a group consisting of a contact switch, an optical sensor, a lead sensor, a hole sensor, and an electronic pen.

4. The playing apparatus according to claim 1, wherein the audio book includes a hole sensor and an electronic pen identification mark, and the MCU determines a kind of the audio book based on a hole sensor sensing signal output from the audio book page sensing unit and determines page location information based on an electronic pen sensing signal.

5. The playing apparatus according to claim 1, further comprising a buffer for storing the audio book data when the voice card insertion signal is input during the output of the audio book data.

6. A method for controlling a playing apparatus for voice card and audio book for outputting audio data from a voice card and an audio book, the voice card including a bar code indicating a location address of audio data, the method comprising the steps of:
a) determining whether a sensing signal is input from an audio book page sensing unit;
b) reading the sensing signal and determining an address of the audio book and page corresponding to the sensing signal when it is determined in the step a) that the sensing signal is input;
c) applying data of the audio book corresponding to the address determined in the step b) to a digital information processing unit;
d) outputting the audio data decoded in the digital information processing unit through a speaker;
e) determining whether a voice card insertion signal is input during the output of the audio data;
f) stopping the output of the audio data of the audio book and storing remaining decoded data when it is determined that the voice card insertion signal is input;
g) driving a card transfer unit;
h) reading a signal input from a voice card sensing unit and determining a bar code and an address of voice card audio data corresponding to the bar code, based on the signal;
i) applying the voice card audio data corresponding to the address determined in the step h);
j) outputting the data decoded in the digital information processing unit through the speaker;
k) determining whether the output of the data decoded in the digital information processing unit is completed; and
l) outputting the data of the audio book stored in step f) through the speaker when it is determined in the step k) that the output of the data decoded in the digital information processing unit is completed.

7. The method according to claim 6, wherein the remaining decoded data stored in the step f) are stored in a buffer.
